(19) United States
(12) Patent Application Publication
(10) Pub. No.: US 2003/0043208 A1
(43) Pub. Date: Mar. 6, 2003

(54) Dynamic menu system

(76) Inventors: Carl H. Staelin, Haifa (IL); Kristin M. Smith, Meridian, ID (US)

Correspondence Address: HEWLETT-PACKARD COMPANY, Intellectual Property Adminstration, P.O. Box 272400, Fort Collins, CO, 80527-2400, US

(21) Appl. No.: 09/943,863

(22) Filed: Aug. 31, 2001

(51) Int. Cl. G09G 5/00

(52) U.S. Cl. 345/825; 345/810; 345/826; 345/811

(57) ABSTRACT

System for displaying menus are provided. A representative system displays a menu in relation to an open document based upon menu items specified by a main menu module and menu items specified by behaviors associated with the document. Menu items specified by the behaviors associated with the document are merged with the menu items specified by the main menu module. Methods and other systems are also provided.

### FIELD OF THE INVENTION

The present invention relates to a system for displaying a menu in relation to a predetermined document. The system merges menu items specified by a main menu module with menu items specified by a behavior associated with the predetermined document.

### BACKGROUND OF THE INVENTION

In Windows based programs such as, for example, Microsoft Windows ₉₈™, the most common element of control is typically the menu. Typically, all main windows (frame window) have some type of menu associated with them. In Microsoft Windows, the top level of the menu is displayed across the top of the window as a menu bar. Sub-menus are displayed as pop-menus.

During development of a Windows program, adding a menu to a window typically requires:

1. defining the form of the menu in a resource file;

2. loading the menu when your program creates its main window; and

3. processing the menu selections.

Before a menu can be included in an application, the content of the menu must be defined in a resource file. Two types of items may be used to define a menu: menu items (MENUITEMs) and pop-ups (POPUPs). A MENUITEM specifies a final selection. A POPUP specifies a pop-up sub-menu, which may, in itself, contain other menu items or pop-ups. Once the menu has been defined, it may be included in a program by specifying its name when the window is created. More particularly, the window is provided with a pointer or menu handle that points to the menu (main menu). When the window is created, the menu specified by the menu pointer will be displayed on the menu bar.

Object oriented programming tools such as Microsoft Visual Studio and the Microsoft Foundations Classes (MFC) greatly simplify the development of applications. Using these types of tools, the developer determines all menu items that must be presented to a user at run time. Unfortunately, these existing tools require a developer to determine up front what menu items will be needed and where they should be placed in the menu hierarchy. Once the menu items and structure have been determined and implemented, it is very difficult to later, during the development process, add additional menu items to the menu hierarchy. In such a case, the developer is typically required to re-implement most, if not all, of the menu handling system. This requires significant time to replicate and re-implement.

Thus, a heretofore unaddressed need exists in the industry to address the aforementioned deficiencies and inadequacies.

### SUMMARY OF THE INVENTION

The present invention provides a system and method for displaying a menu relevant to a particular document. Briefly described, in architecture, one embodiment of the system, among others, can be implemented as follows. Memory for storing data representing a main menu is provided. The memory is configured to store data representing a predetermined document. The document is associated with a predetermined behavior, and the behavior specifies a predetermined menu fragment. A controller configured to merge the menu fragment with the data representing the main menu is provided.

The present invention can also be viewed as providing methods for providing a menu. In this regard, one embodiment of such a method, among others, can be broadly summarized by the following steps: defining a main menu; defining a document; defining a predetermined behavior that specifies an associated menu fragment; associating the document with the predetermined behavior; and merging the associated menu fragment with the main menu.

Another embodiment of such a method, can be broadly summarized by the following steps: generating a command message in response to selection of a displayed menu item. The command message includes a command ID indicative of a predetermined process. The predetermined process corresponds to the selected menu item. A determination then is made as to whether the command ID corresponds to a predetermined behavior. The process represented by the predetermined behavior is initiated where it is determined that the command ID corresponds to a predetermined behavior associated with a predetermined document.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram illustrating a representative document and a list of behaviors associated with the document;

FIG. 2 is a diagram showing a representative frame window and a menu bar;

FIG. 3 is a diagram illustrating a representative main menu module;

FIG. 4A is a diagram further illustrating a representative main menu module;

FIG. 4B is a diagram illustrating a representative frame window displaying a menu in accordance with the main menu module;

FIG. 5 is a diagram further illustrating behavior objects associated with a document;

FIG. 6 is a flowchart illustrating the process of displaying a menu according to an embodiment of the invention;

FIG. 7 is a further illustration describing the process of displaying a menu in accordance with an embodiment of the present invention;

FIG. 8A and FIG. 8B are diagrams illustrating a representative frame window showing a merged menu;

FIG. 9 is a block diagram of a system for displaying a menu according to an embodiment of the invention; and

FIG. 10 is a flowchart illustrating a representative process of responding to the selection of a displayed menu item.

### DETAILED DESCRIPTION

As noted above, systems and methods for displaying a menu are disclosed herein. To facilitate description of the invention, an example system will be discussed with reference to the figures. Although this system is described in detail, it will be appreciated that this system is provided for purposes of illustration only and that various modifications are feasible without departing from the inventive concept.

The present invention provides for the display of a menu relevant to a particular document. This is achieved by merging menu fragments, preferably specified by behavior objects associated with the document, with a predefined main menu.

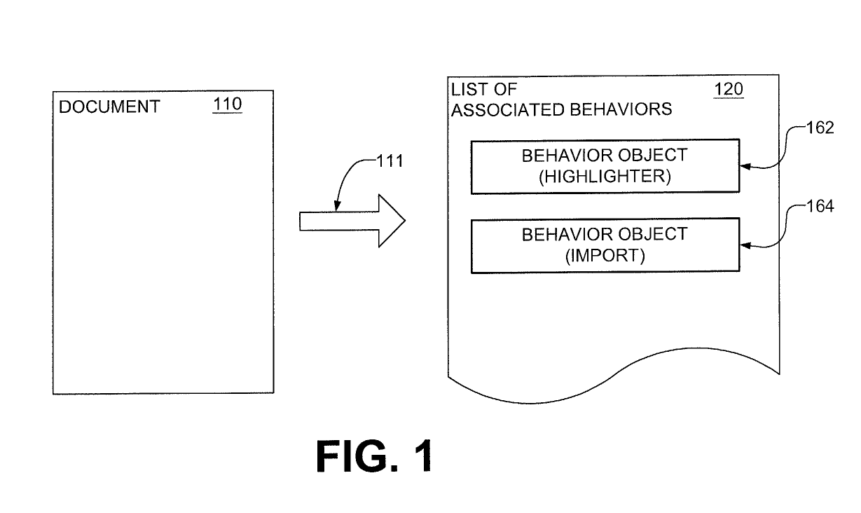

Referring now in more detail to the drawings, in which like numerals indicate corresponding parts throughout the several views, FIG. 1 shows a document 110. The document 110 includes a pointer 111 to a list of associated behaviors 120. This list of associated behaviors 120 identifies manager class behavior objects (behaviors) 162, 164 that are associated with the document 110. Behavior 162 corresponds to a highlighting function (HIGHLIGHTER) whereby a selected portion of the document 110 may be emphasized by, for example, application of a highlighting color to the selected portion of the document 110. Behavior 164 corresponds to an importing function (IMPORT) whereby additional data may be introduced into the document 110. Document 110 is data associated with a program and may be any form of data. It is not limited to, for example, a text file. In short, a document may be a unit of data operated upon by a program.

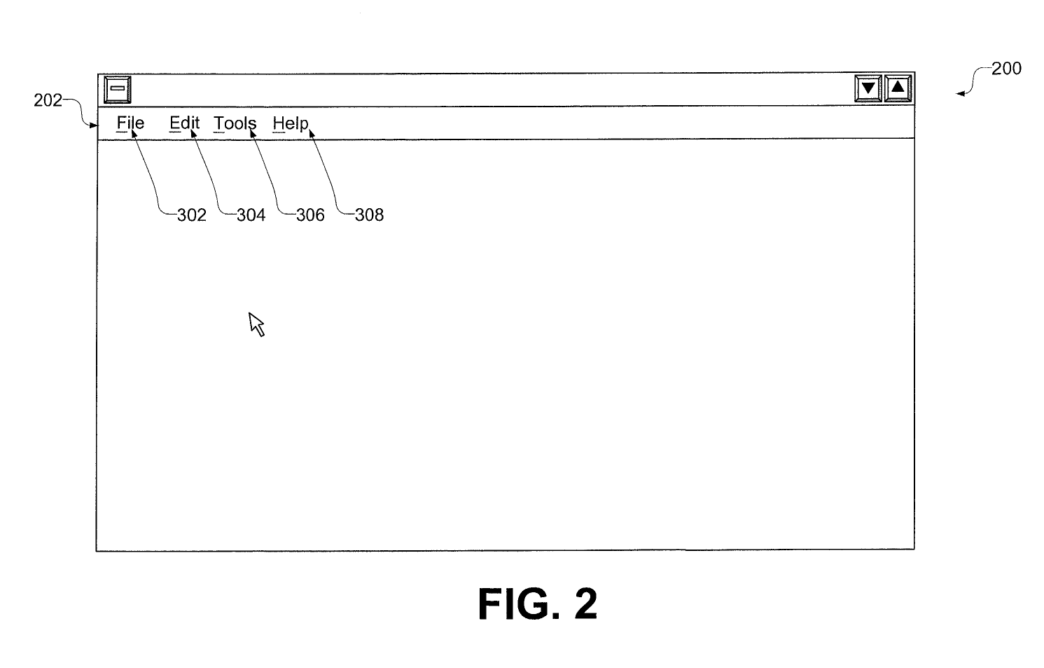

With further reference to FIG. 2, when a program is run and a document 110 is opened, a frame window 200 will be displayed. The frame window includes a menu bar 202. The menu bar will show various menu headers. In this example the menu bar 202 includes menu headers 302, 304, 306 and 308. Under each of these headers relevant menu items will appear. The menu headers 302, 304, 306 and 308 correspond to various behaviors/operations that may be carried out with respect to the document 110. The menu header 302 is FILE. Menu header 304 is EDIT. Menu item 306 is TOOLS. Menu header 308 is HELP.

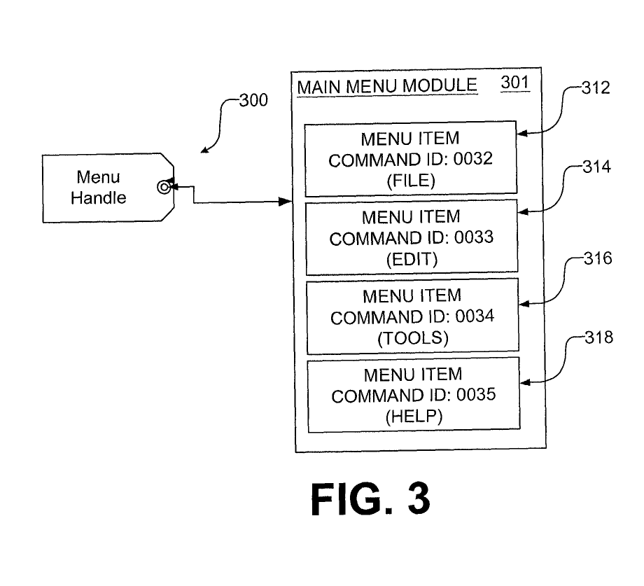

With reference to FIG. 3, the frame window 200 (FIG. 2) has a menu handle 300 associated with it that points to main menu module 301. The main menu module specifies components of the menu that will appear as a part of the frame window 200 when the document 110 (FIG. 1) is opened. The main menu module 301 represents a main menu that may be common to all documents. The main menu module 301 specifies various menu items 312, 314, 316 and 318 that should be displayed on the menu bar 202 of the frame window 200. Each menu item may also be referred to as a menu node. The menu comprises a hierarchy of menu nodes. Each node represents a functional operation and/or associated related functional operation.

The document is associated with a predetermined list of manager class objects. This list specifies the various functional operations that may be carried out in relation to the document when it is opened. Each manager class object specified in the list represents a predetermined functional operation.

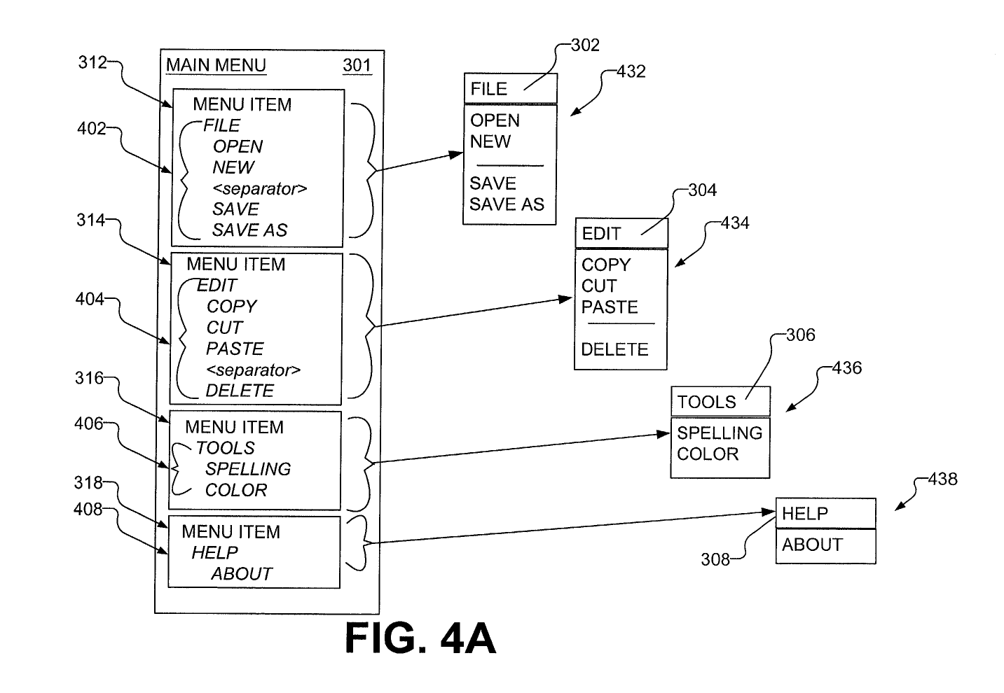

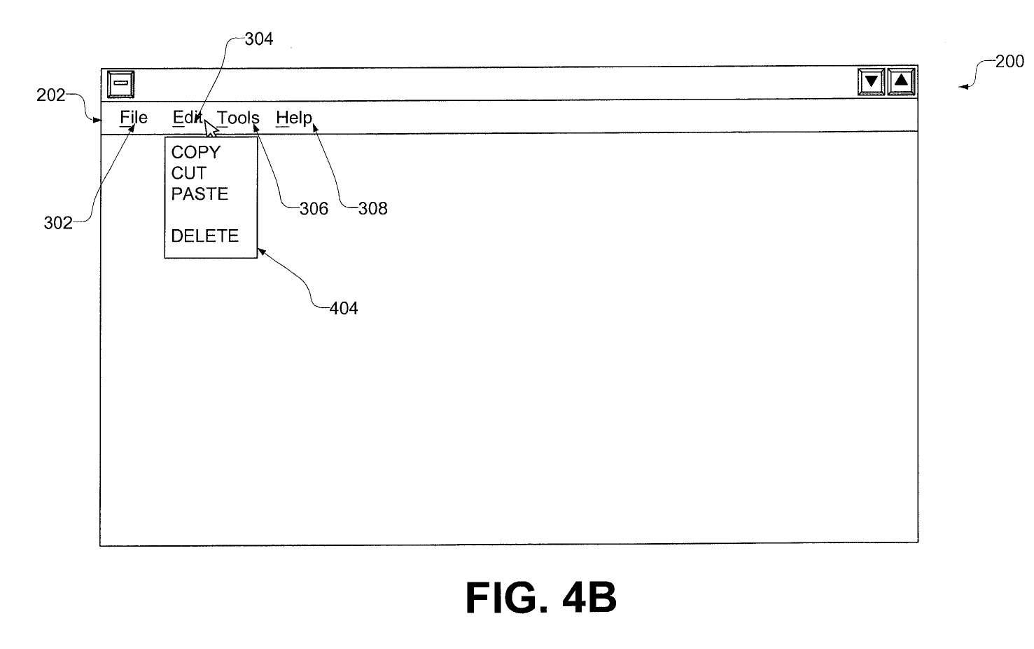

FIG. 4A further illustrates main menu module 301. Each menu item 312, 314, 316 and 318 specifies a menu fragment that will appear on the menu bar 202 (FIG. 2) under a predetermined menu header. Menu item 312 specifies that the menu fragment 402 includes menu items for the operations OPEN, NEW, SAVE and SAVE AS. A separator is disposed between NEW and SAVE. Based upon the menu item 302, the menu 432 will appear on the menu bar 202 (FIG. 2) when selected. Similarly, menu item 314 specifies that the menu fragment 404 includes menu items for the operations COPY, CUT, PASTE and DELETE. A separator is disposed between PASTE and DELETE. Based upon the menu item 314, the menu 434 will appear on the menu bar 202 (FIG. 2) when selected. Menu item 316 specifies that the menu fragment 406 includes menu items for the operations SPELLING and COLOR. Based upon the menu item 316, the menu 436 will appear on the menu bar 202 (FIG. 2) when selected. Menu item 318 specifies that the menu fragment 408 includes menu items for the operations ABOUT. Based upon the menu item 318, the menu 438 will appear on the menu bar 202 (FIG. 2) when selected. Each menu item 312, 314, 316 and 318 has a command identifier (COMMAND ID) associated with them that corresponds to the particular function represented by the menu item. FIG. 4B further illustrates how data specified by the main menu module 301 may be displayed. More particularly, the menu fragment 404 specified by menu item 314 is displayed on frame window 200 when selected. It can be seen that a drop down menu (or POP-UP) is displayed that sets out each of the menu items COPY, CUT PASTE and DELETE.

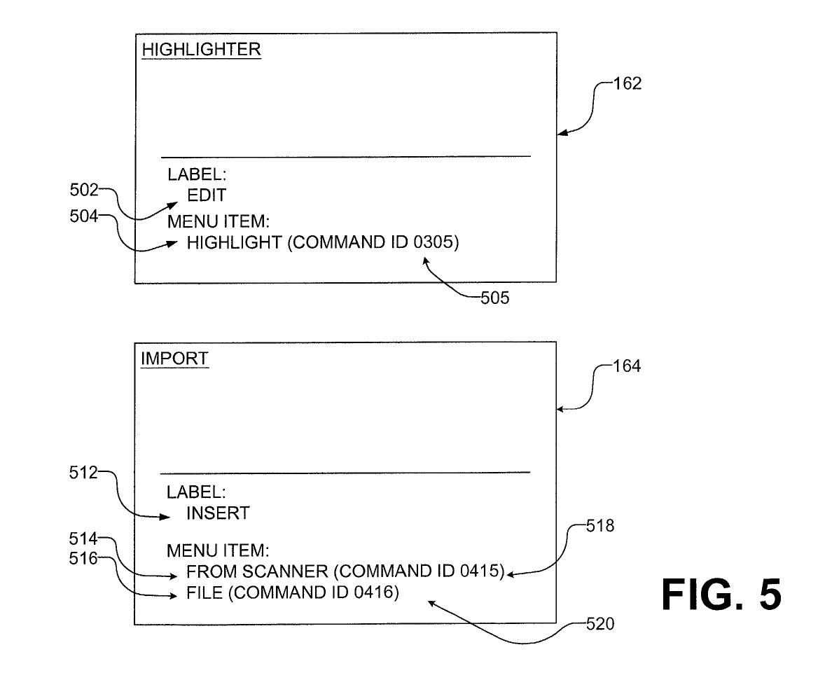

When document 110 (FIG. 1) is opened, or run, the pointer 111 causes the list of associated objects 120 to be searched and relevant information and operations to be retrieved and/or carried out. FIG. 5 illustrates some attributes of behavior objects 162 and 164. Behavior 162 corresponds to a HIGHLIGHTER operation. Behavior 162 specifies a label 502 and a menu item 504. The menu item 504 corresponds to a COMMAND ID 505. In this case, the label 502 is EDIT. This label specifies that the menu item 504 should appear on the menu bar 202 (FIG. 2) under the menu header EDIT when the menu item 504 is merged with the main menu module 301 (FIG. 3). Similarly, the behavior 164 specifies a label 512 and a menu item 514. The menu item 516 corresponds to a COMMAND ID 520. In this case, the label 512 is INSERT. This label specifies that the menu item 514 should appear on the menu bar 202 (FIG. 2) under a menu header of INSERT when the menu item 514 is merged with the main menu data 301.

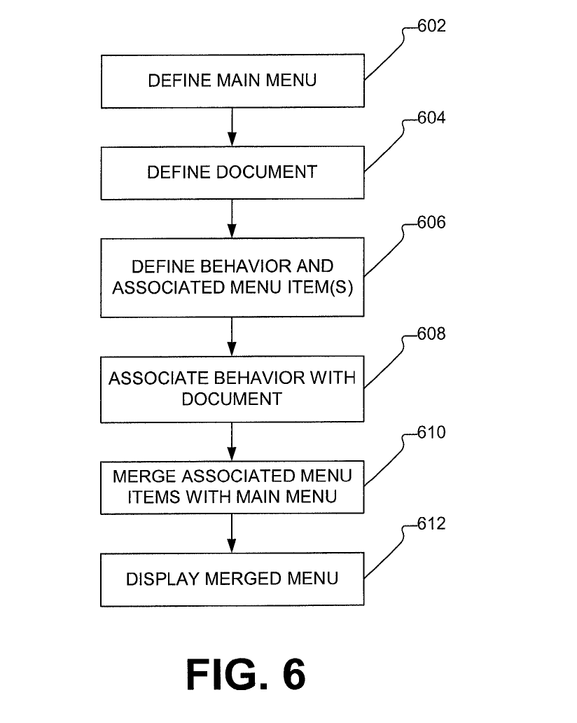

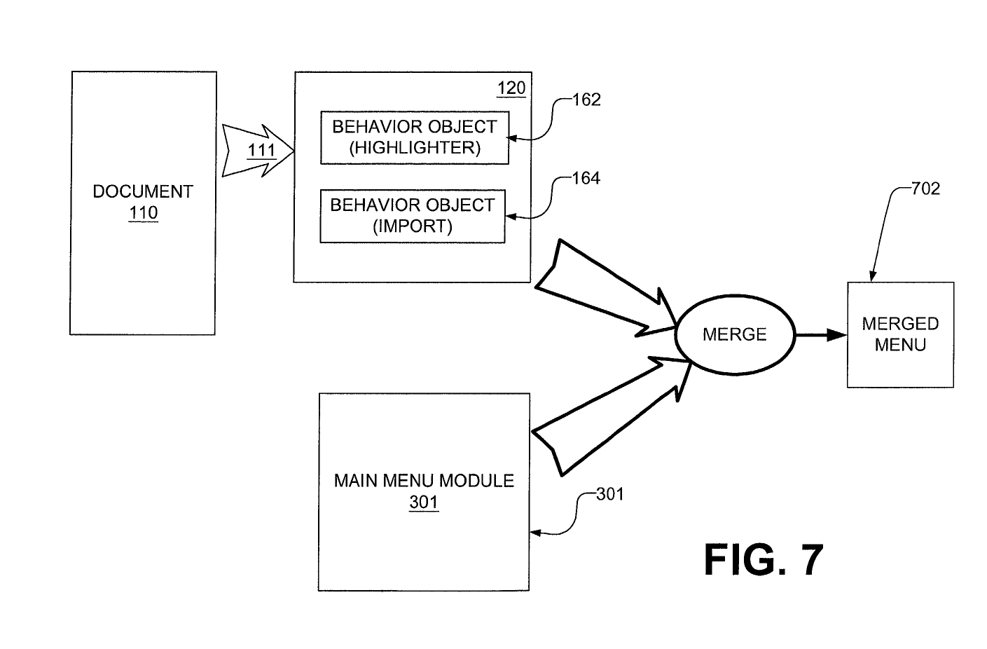

FIG. 6 is a flowchart illustrating a representative method of the present invention. FIG. 7 is a simplified diagram illustrating the method of FIG. 6. With reference to FIG. 6 and FIG. 7, this method will be discussed. A main menu is defined (602). This main menu is represented by a main menu module 301 (FIG. 3). The main menu specifies menu items and menu headers that may be displayed for all documents. A document 110 is defined (604). This document 110 may be composed of any type of data. Depending upon the type of operations that may need to be carried out on the document 110 in order to obtain desired results, certain operations represented by behavior objects 162 and 164 may be defined (606). As these behaviors 162 and 164 are typically unique to the document 110, the defined behaviors are associated with the document 110 (608). This may be carried via identifying the defined behavior(s) on a list 120 of behaviors that are associated with the document 110. Each behavior 162, 164 may specify menu items to appear on a menu bar to allow for a control/activation of the particular behavior/operation. When a document 110 is opened, menu items specified by the main menu will be merged with menu items specified by the behaviors identified in the list 120 of associated behaviors (610). The merged menu 702 will be displayed so as to include both the menu items of the main menu as well as the menu items specified by the associated behaviors (612).

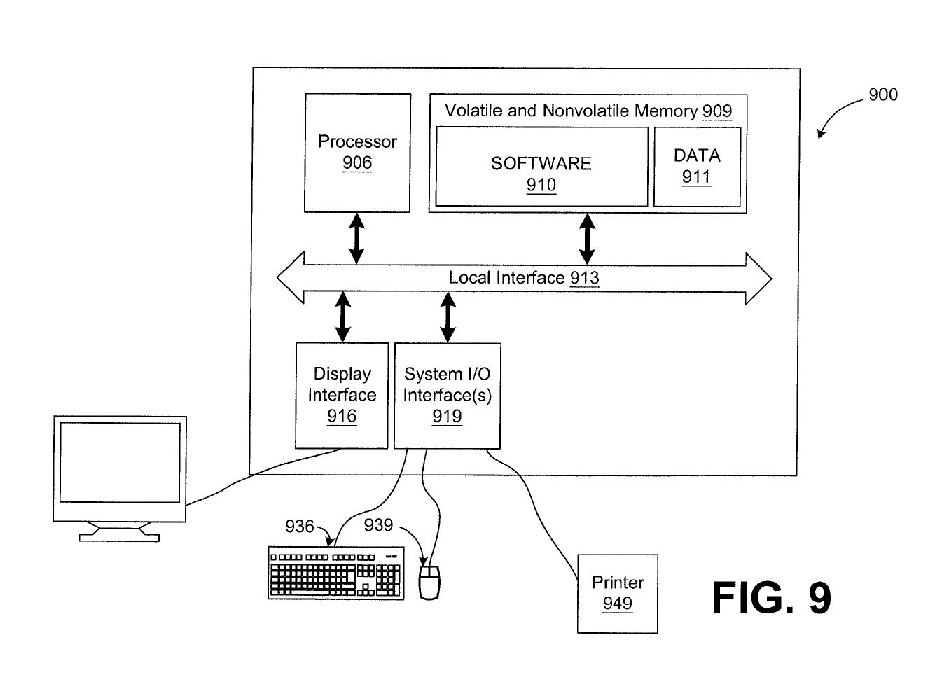

The flow chart of FIG. 6 shows the architecture, functionality, and operation of a possible implementation of the control software that may be stored on memory 906 (FIG. 9) as software 910. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved, as will be further clarified hereinbelow.

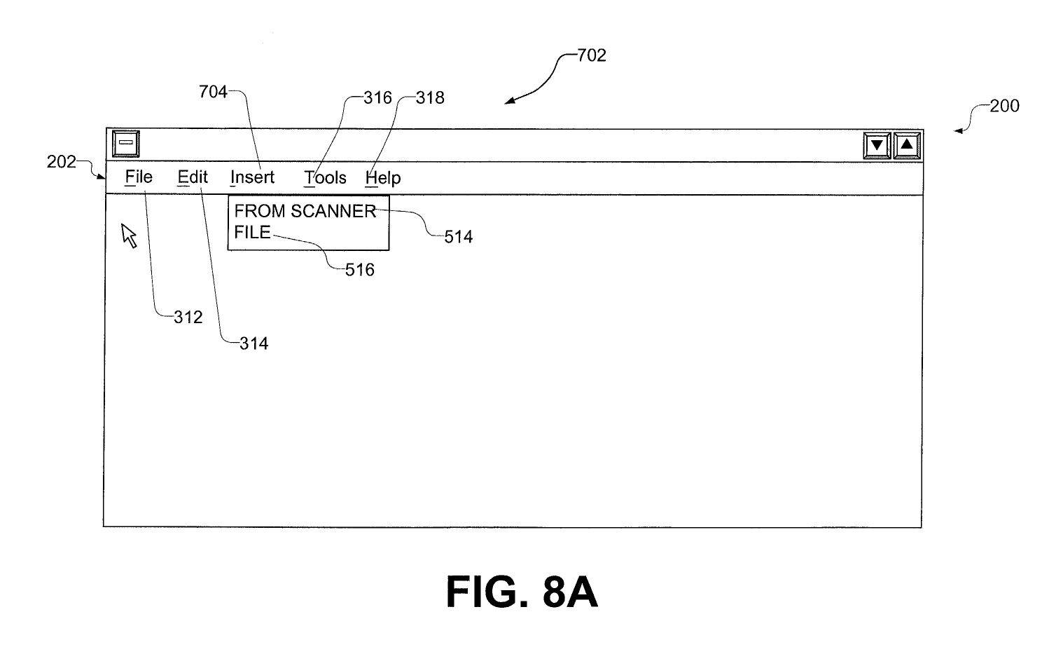

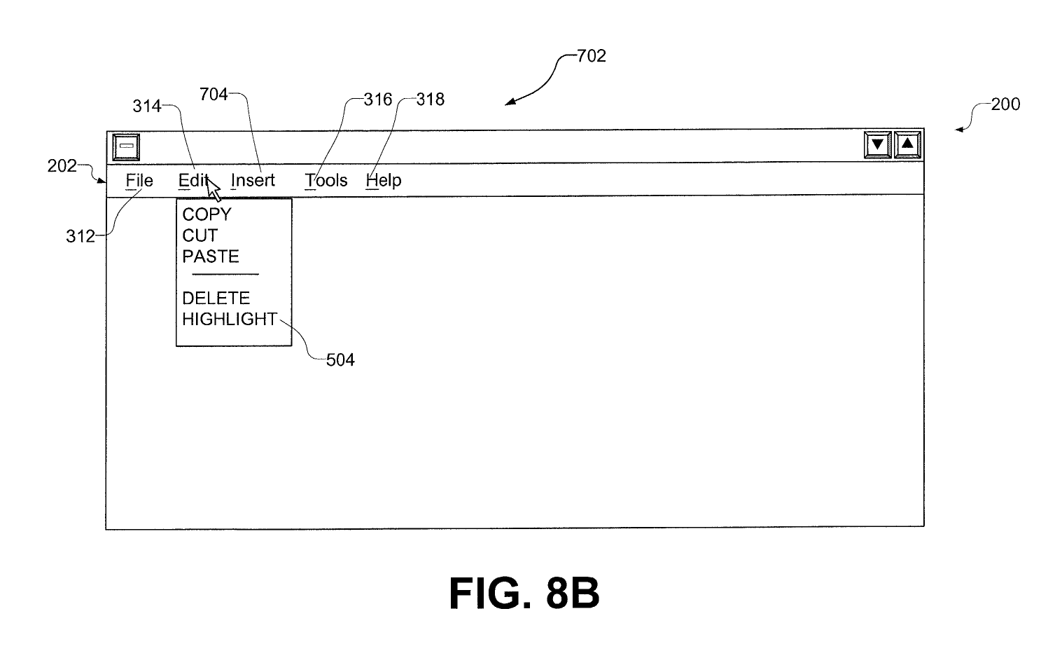

FIG. 8A shows an illustration depicting an example of a merged menu 702. It can be seen that the menu bar 202 includes the menu headers 312, 314, 316 and 318 that are specified by the main menu module 301 (FIG. 3). With reference to FIG. 8A and FIG. 5, the menu bar 202 includes the menu items specified by the behavior 164. More particularly, the menu items 514 (FROM SCANNER) and 516 (FILE) are shown beneath a menu header 704 (INSERT) that corresponds to label 512 (INSERT). FIG. 8B shows another example. Here it can be seen that the menu item 504 (HIGHLIGHT) specified by the behavior 162 appears under the menu header 314 (EDIT) that corresponds to the label 502 (EDIT).

In one embodiment of the present invention, menu items specified by behaviors identified on the associated behaviors list 120 will be merged with main menu, menu items in alphabetical order. Further, where a label specified by a behavior indicates a menu header that is not included as a part of the main menu module 301, a new menu header with the name of the specified label will be inserted on the menu bar 202.

Referring to FIG. 9, shown is a block diagram of a system 900 for displaying a menu in relation to a document according to an embodiment of the present invention. The system 900 includes a processor 906, a memory (VOLATILE AND NONVOLATILE) 909, both of which are coupled to a data bus 913. The system 900 further includes a display interface 916, and a system I/O interface 919 both of which are also coupled to the data bus 913. The I/O interface 919 which interfaces with input devices such as keyboard 936 and mouse/pointing device 939.

The system 900 also includes application software 910, which is generally stored on the memory 909 along with data 911. When the system 900 is operational, pertinent portions of the software 910 are loaded into the memory 909 and is executed by the processor 906. During operation of the system 900, the software 910 may access the data 911 stored on the memory 909.

Processor 906 is preferably configured to merge associated menu items with the main menu items specified by the main menu module 301 (FIG. 3). Main menu module 301 may be stored to memory 906 as data 911. Further, document 110 may be stored to memory 909 as data 911, along with data representing the list of associated behaviors 120. Processor 906 is preferably configured to search for behavior objects specified by the list of associated behaviors 120 and retrieve menu items specified therein. Further, processor 906 is configured to compare the label associated with a given behavior object with menu headers specified by the main menu module 301. If the label corresponds to a menu header specified by the main menu module, the menu item specified by the behavior object will be added to the menu and displayed under the specified menu header. If no such menu header exists, it will then be created and displayed.

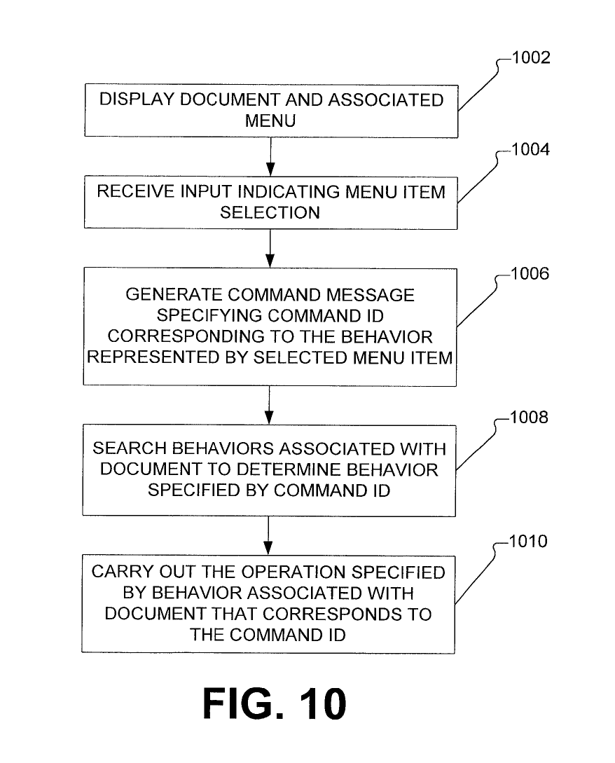

When a menu item is selected from a displayed menu, the present invention provides a command message that specifies a COMMAND ID that correlates to the selected menu item. Behaviors associated with the document are searched to determine the behavior to which the specified COMMAND ID corresponds. If the corresponding behavior is found, the corresponding operation will be carried out in relation to the document. FIG. 10 is a flowchart illustrating the process of carrying out an operation correlating to a selection of a displayed menu item. A document and associated menu is displayed (1002). Input is received indicating when a displayed menu item has been selected (1004). A command message is then generated that specifies a COMMAND ID that corresponds to the operation represented by the selected menu item (1006). Behaviors associated with the opened document are searched to determine if they correspond to the specified COMMAND ID (1008). If a behavior associated with the menu is determined to correspond with the COMMAND ID specified by the command message, then the operation specified by the COMMAND ID will be carried out in relation to the document (1010).

The flow chart of FIG. 10 shows the architecture, functionality, and operation of a possible implementation of the control software that may be stored on memory 906 (FIG. 9) as software 910. In this regard, each block represents a module, segment, or portion of code, which comprises one or more executable instructions for implementing the specified logical function(s). It should also be noted that in some alternative implementations, the functions noted in the blocks may occur out of the order noted in FIG. 10. For example, two blocks shown in succession in FIG. 10 may in fact be executed substantially concurrently or the blocks may sometimes be executed in the reverse order, depending upon the functionality involved. It will be noted and understood that the system 900 of FIG. 1 may be further configured to carry out the methodology described in FIG. 10

The processor 906, of the present invention can be implemented in hardware, software, firmware, or a combination thereof. In the preferred embodiment(s), the processor 906 is implemented in software or firmware that is stored in a memory and that is executed by a suitable instruction execution system. If implemented in hardware, as in an alternative embodiment, the processor 906 can be implemented with any or a combination of the following technologies, which are all well known in the art: a discrete logic circuit(s) having logic gates for implementing logic functions upon data signals, an application specific integrated circuit having appropriate logic gates, a programmable gate array(s) (PGA), a fully programmable gate array (FPGA), etc.

Implementation of the system and method of the present invention may be carried out in a Microsoft Foundations Classes (MFC) environment. Further, software 910 comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the present invention and protected by the following claims.

Therefore, having thus described the invention, at least the following is claimed:

1. A method of providing a menu in relation to a predetermined document, the method comprising the steps of:
creating a main menu;
creating a list of associated behaviors;
defining a document;
defining a predetermined behavior;
associating said document with said behavior;
specifying said behavior on said list of associated behaviors; and
said document comprises a pointer to said list of associated behaviors.

2. The method of claim 1, wherein said main menu comprises a first menu item.

3. The method of claim 1, wherein said step of defining a predetermined behavior further comprises the step of defining an associated menu fragment wherein said menu fragment comprises a predetermined menu item.

4. The system of claim 2, wherein said method further comprises the step of merging said second menu item with said main menu.

5. A method of providing a menu in relation to a predetermined document, the method comprising the steps of:
defining a main menu;
defining a document;
defining a predetermined behavior, said predetermined behavior comprising an associated menu fragment;
associating said document with said predetermined behavior;
merging said associated menu fragment with said main menu; and
displaying a merged menu comprised of said main menu and said associated menu fragment.

6. The method of claim 5, wherein said main menu comprises a predetermined menu item.

7. The method of claim 5, wherein said step of associating said document with said predetermined behavior comprises the step of creating a list of behaviors associated with said document.

8. The system of claim 7, wherein said step of defining said document comprises the step of defining a pointer to said list of behaviors.

9. A system for displaying a menu on a display device in relation to a predetermined document, the system comprising:
memory for storing data representing a main menu;
said memory is further configured to store data representing a predetermined document;
said predetermined document is associated with a predetermined behavior, said behaviors comprising a specification of a predetermined menu fragment; and
controller configured to merge said menu fragment with said data representing said main menu.

10. The system of claim 9, wherein said controller is further configured to and generate a signal representative of a merged menu comprising said menu fragment and said main menu.

11. The system of claim 10, wherein said controller is further configured to output said signal representative of said merged menu to said display device.

12. A method of providing a menu in relation to a predetermined document, the method comprising the steps of:
receiving user input;
generating a command message in response to said user input;
said command message comprises a command ID indicative of a predetermined process;
said predetermined process corresponds to a selected menu item;
determining if said command ID corresponds to a predetermined behavior;
initiating a process represented by said predetermined behavior where it is determined that said command ID corresponds to said predetermined behavior.

13. The method of claim 12, wherein said predetermined behavior is associated with said predetermined document.

14. The method of claim 12, wherein said user input comprises selection of a displayed menu item.

15. A system for providing a menu in relation to a predetermined document, said system comprising:
input interface for receiving user input;
processor configured to generate a command message in response to said user input; and
said processor is further configured to carry out a predetermined process in response to said command message, said processor is associated with said predetermined document.

16. The system of claim 15, wherein said command message comprises a command ID that corresponds to a selected menu item.

17. The system of claim 16, wherein said processor is further configured to determined whether said command ID corresponds to a behavior associated with said predetermined document.
